(19) United States
(12) Patent Application Publication
(10) Pub. No.: US 2009/0119732 A1
(43) Pub. Date: May 7, 2009

(54) METHOD AND SYSTEM FOR DIRECT SAMPLED DIGITAL AND ANALOG DEMODULATOR TV RECEIVER WITH BACKWARDS COMPATIBILITY

(76) Inventors: Thomas Spieker, San Juan Capistrano, CA (US); Charles A. Brooks, Laguna Beach, CA (US)

Correspondence Address: MCANDREWS HELD & MALLOY, LTD, 500 WEST MADISON STREET, SUITE 3400, CHICAGO, IL, 60661, US

(21) Appl. No.: 11/934,291

(22) Filed: Nov. 2, 2007

(51) Int. Cl. H04N 7/173

(52) U.S. Cl. 725/117

(57) ABSTRACT

A second coaxial-connector may be added to a TV receiver that directly samples digital or analog format TV signals, which may be received via a first coaxial-connector. The second coaxial-connector may enable backwards compatibility with one of plurality of available consumer audiovisual devices, wherein Audio/Video (A/V) analog and/or digital modulation format feeds from the consumer audiovisual device may be inputted directly into the TV receiver via the second coaxial-connector. The A/V feed from the consumer audiovisual devices may be demodulated via a common demodulator for similarly modulated TV signals in the TV receiver. Filtering and/or amplification of the local A/V feed may be performed via dedicate components; however, analog-to-digital conversion of the local A/V feed may either be performed via the dedicated converter or via a common-path converter. The local A/V feed may also be demodulated directly, via a dedicated demodulator.

### CROSS-REFERENCE TO RELATED APPLICATIONS/INCORPORATION BY REFERENCE

[Not Applicable].

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to improving television processing. More specifically, certain embodiments of the invention relate to a method and system for a direct sampled digital and analog demodulator TV receiver supporting backwards compatibility.

### BACKGROUND OF THE INVENTION

TV broadcasts generally may be transmitted via RF carriers, via broadcast channels. For example, over-the-air terrestrial TV broadcasts may comprise, in the U.S., channels 2 through 69; and Cable-Television (CATV) broadcasts may utilize even greater number of channels, for example up to channel 125. TV broadcasts may comprise transmission of video and/or audio information, wherein the video and/or audio information may be encoded into the broadcast channels via one of plurality of available modulation schemes. TV Broadcasts may utilize analog and/or digital modulation format. Analog modulation format schemes may comprise, for example, NTSC, PAL, or SECAM; audio encoding may comprise utilization of separate modulation scheme, comprising, for example, BTSC, NICAM, Korean A-2, mono FM, and/or AM. Additionally, TV broadcasts may comprise digital modulation format schemes, comprising, for example, QAM, VSB, or OFDM. TVs enable displaying TV broadcasts, telecasts, and/or localized Audio/Video (A/V) feeds via one or more available consumer audiovisual devices, such as videocassette recorders (VCRs). Video and/or audio may be inputted into TVs via one or more of available types of connectors including, but not limited to, F-connectors, S-video, composite, and/or video component connectors.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a direct sampled digital and analog demodulator TV receiver supporting backwards compatibility, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating a TV setup that may enable use of various types of TV broadcasts and/or feed from consumer audiovisual devices, in connection with an embodiment of the invention.

FIG. 2 is a block diagram illustrating an exemplary television receiver that utilizes a single coaxial-connector, in connection with an embodiment of the invention.

FIG. 3A is a block diagram illustrating an exemplary television receiver with Channel 3/4 support via a dedicated coaxial-connector, which utilizes a separate Analog-to-Digital Converter (ADC) for Channel 3/4 processing, in accordance with an embodiment of the invention.

FIG. 3B is a block diagram illustrating an exemplary television receiver with Channel 3/4 support via a dedicated coaxial-connector, which utilizes a common Analog-to-Digital Converter (ADC) for signal processing, in accordance with an embodiment of the invention.

FIG. 3C is a block diagram illustrating an exemplary television receiver with Channel 3/4 support via a dedicated coaxial-connector, which utilizes a common Analog-to-Digital Converter (ADC) and a single amplifier for signal processing, in accordance with an embodiment of the invention.

FIG. 3D is a block diagram illustrating an exemplary television receiver with Channel 3/4 support via a dedicated coaxial-connector, which utilizes a common tuner, in accordance with an embodiment of the invention.

FIG. 3E is a block diagram illustrating an exemplary television receiver with Channel 3/4 support via a dedicated coaxial-connector, which utilizes a dedicated Channel 3/4 demodulator, in accordance with an embodiment of the invention.

FIG. 4 is an exemplary flow diagram illustrating a television receiver with Channel 3/4 support via a dedicated coaxial-connector, in accordance with an embodiment of the invention.

### DETAILED DESCRIPTION OF THE INVENTION

Certain embodiments of the invention may be found in a method and system for a direct sampled digital and analog demodulator TV receiver supporting backwards compatibility. A TV receiver may be utilized to directly sample digital and/or analog modulation format TV signals that may be received via a first coaxial-connector from one or more of available TV broadcast head-ends. A tuner may be utilized to tune in to a broadcast channel. The TV receiver may enable processing of TV signals comprising analog modulation format schemes such as NTSC, PAL, and/or SECAM; audio modulation schemes such as BTSC, NICAM, Korean A-2, mono FM, and/or AM; and/or digital modulation format scheme such as QAM, VSB, and/or OFDM. Processing operations may comprise filtering, via SAW filters, analog-to-digital conversions, via analog-to-digital converters (ADC), and signal demodulation, via analog-specific and/or digital-specific demodulators, to extract video and/or audio contents. A second coaxial-connector may be added in the TV receiver to ensure backwards compatibility with one of plurality of available consumer audiovisual devices, wherein Audio/Video (A/V) analog and/or digital modulation format feeds from the consumer audiovisual device may be inputted directly into the TV receiver via the second connector. The A/V feed from the consumer audiovisual devices may be demodulated via a common demodulator for similarly modulated TV signals in the TV receiver. Filtering and/or amplification of the local A/V feed may be performed via dedicated components; however, analog-to-digital conversion of the local A/V feed may either be performed via the dedicated converter or via a common-path converter. The local A/V feed may also be demodulated directly, via a dedicated demodulator.

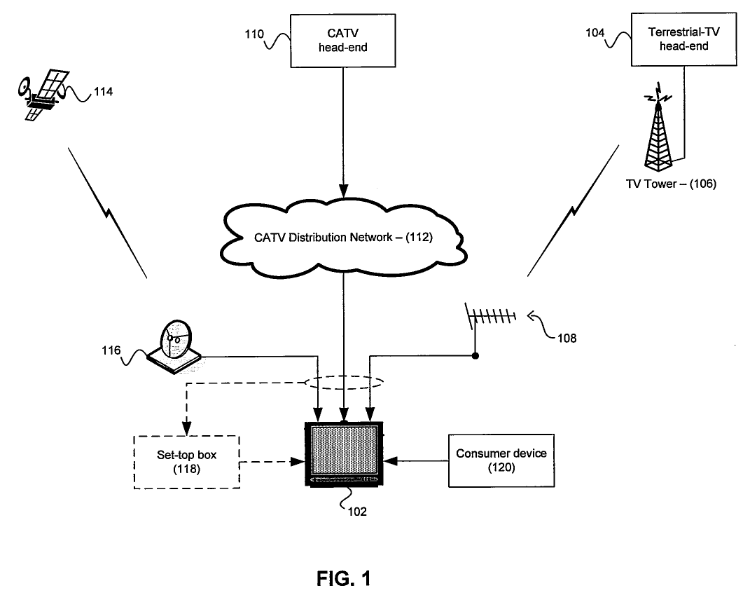

FIG. 1 is a block diagram illustrating a TV setup that may enable use of various types of TV broadcasts and/or feed from consumer audiovisual devices, in connection with an embodiment of the invention. Referring to FIG. 1, there is shown a TV 102, a terrestrial-TV head-end 104, a TV tower 106, a TV antenna 108, a cable-TV (CATV) head-end 110, a cable-TV (CATV) distribution network 112, a satellite head-end 114, a satellite receiver 116, a set-top box 118, and a consumer audiovisual device 120.

The TV 102 may comprise suitable logic, circuitry, and/or code that may enable outputting/displaying TV video and audio.

The terrestrial-TV head-end 104 may comprise suitable logic, circuitry, and/or code that may enable over-the-air broadcast of TV signals, via one or more of TV towers 106. The terrestrial-TV head-end 104 may broadcast analog format and/or digital format terrestrial TV signals. The TV antenna 108 may comprise suitable logic, circuitry, and/or code that may enable reception of TV signal transmitted by the terrestrial-TV head-end 104, via the TV tower 106.

The CATV head-end 110 may comprise suitable logic, circuitry, and/or code that may enable communication of analog format and/or digital format cable-TV signals. The CATV distribution network 112 may comprise suitable distribution systems that may enable forwarding of communication from the CATV head-end 110 to the TV 102. For example, the CATV distribution may comprise a network of fiber optics and/or coaxial cables that enable connectivity between the CATV head-end 110 and the TV 102.

The satellite head-end 114 may comprise suitable logic, circuitry, and/or code that may enable down link communication of satellite-TV signals to terrestrial recipients, such as the TV 102. The satellite receiver 116 may comprise suitable logic, circuitry, and/or code that may enable reception of downlink satellite-TV signals transmitted by the satellite-TV head-end 114. Additionally, because most satellite downlink feeds may comprise security encoding and/or scrambling, the satellite receiver 114 may also suitable logic, circuitry, and/or code that may enable decoding and/or descrambling of received satellite-TV feeds.

The set-top box 118 may comprise suitable logic, circuitry, and/or code that may enable processing of TV signals transmitted by a head-end, for example the terrestrial-TV head-end 104, the CATV head-end 110, and/or the satellite-TV head-end 114, external to the TV 102.

The consumer audiovisual device 120 may comprise suitable logic, circuitry, and/or code that may enable inputting of TV-like digital or analog formatted video feed into the TV 102. For example, the consumer audiovisual device 120 may comprise a videocassette recorder (VCR) that may enable inputting, into the TV 102, pre-recorded video and/or audio feeds. Other examples of consumer devices may comprise a digital video disc (DVD) player, a digital video recorder (DVR), a video game console, a surveillance system, a personal computer (PC) capture/playback card, and/or stand-alone CH3/4 modulator box.

In operation, the TV 102 may be utilized to display TV broadcasts received from one of available head-ends. The TV 102 may receive, via the TV antenna 100, over-the-air broadcast from the terrestrial-TV head end 104 transmitted via the TV tower 104. The TV 102 may also receive Cable-TV broadcast, which may be communicated by the CATV head-end 110 via the CATV distribution network 112. Finally, the TV 102 may receive, via the satellite receiver 116, satellite TV broadcast, which may be communicated by the satellite head-end 114.

Received TV broadcasts generally may be transmitted via RF carriers, wherein frequencies, or more specifically bands of frequencies, may correspond to specific broadcast channels. For example, over-the-air terrestrial TV broadcasts may comprise, in the U.S., channels 2 through 69; and CATV broadcasts may utilize even greater number of channels, for example up to channel 125. TV broadcasts may comprise transmission of video and/or audio information, wherein the video and/or audio information may be encoded into the carrier frequency via one of plurality of available modulation scheme.

Broadcast head-ends may utilize analog and/or digital modulation format in TV broadcasts. Historically, TV broadcasts utilized analog modulation format schemes, comprising, for example, NTSC, PAL, or SECAM. Additionally, audio encoding may comprise utilization of separate modulation scheme, comprising, for example, BTSC, NICAM, Korean A-2, mono FM, and/or AM. More recently, there has been a steady move toward utilizing, for TV broadcasts, digital modulation format schemes, comprising, for example, QAM, VSB, or OFDM. For example, while terrestrial-TV has been primarily analog-based broadcast, digital TV is becoming more available. The terrestrial-TV head-end 104 may utilize analog modulation format, for example NTSC, and/or digital system such as HDTV.

In addition to the rapid developments in broadcast technology, there has been also a steady change in other aspects of the TV broadcast. For example, while early setups were limited to direct feeds into TVs, use of such devices as set-top boxes has increased. For example, the set-top box 118 may be utilized to perform certain processing functionality external to the TV 102 itself. The set-top box 118 may be utilized to descramble CATV broadcast that may be encrypted by CATV providers. Another aspect of TV broadcast that has seen substantial growth is connector technology. Traditionally, the most common setup utilized TVs and antennas, wherein a single coaxial-connector, for example an F-connector, may have been utilized to provide TV feed, received via an antenna, into TVs. Nowadays, other types of connectors, comprising, for example, S-video, composite, and/or video component connectors.

While TVs may be utilized primarily in conjunction with TV broadcasts from TV head-ends, they may also be utilized in to play audio/video (A/V) feeds from local sources. For example, the consumer audiovisual device 120 may be utilized to input into the TV 102 a video and/or audio feeds. Various types of local sources may be utilized to provide localized A/V feeds. For example, videocassette recorder (VCRs) were introduced in the later 1970s, and remained popular for long time afterwards. A VCR may be utilized to record and/or play audio/video (A/V) clips via the TV 102. The consumer audiovisual device 120 may be designed to work with specific format and/or specific connector, and may not be configurable to accommodate newer technologies and/or connector types. For example, with VCRs, the A/V feeds was generated utilizing channel 3 (60-66 MHz) and/or channel 4 (66-72 MHz), utilizing analog modulation format, for example NTSC, and connectivity to TVs was generally limited to use of coaxial-connectors. With the rapid transition to newer technologies, most TVs now may only have a single F-connector/tuner connector integrated thereon. Therefore, if that single coaxial-connector was utilized for receiving TV broadcast from TV head-ends, the consumer audiovisual device 120 may have to be disconnected. Because A/V feeds from the consumer audiovisual device 120 may be limited to a single or few pre-set channels, there may not be a need for full tuning to facilitate reception of A/V feeds in the TV 102. Consequently, a second coaxial-connector, dedicated for localized A/V feeds from consumer audiovisual devices may enable continued backward compatibility at minimal cost and/or added processing.

Additionally, because the set-top-box 118 may also utilize channel 3 and/or channel 4 in re-transmitting a TV broadcast received from a TV head-end, the second coaxial-connector may also facilitate reception of A/V feeds, from the set-top-box 118, in the TV 102.

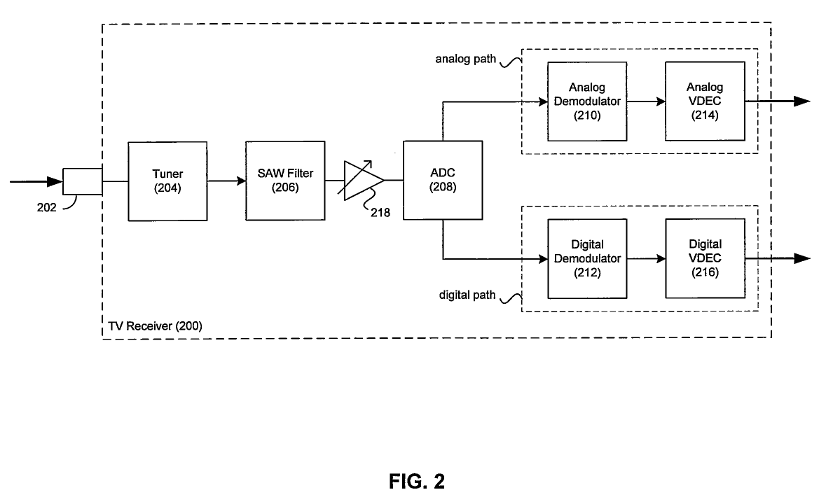

FIG. 2 is a block diagram illustrating an exemplary television receiver that utilizes a single coaxial-connector, in connection with an embodiment of the invention. Referring to FIG. 2, there is shown a TV receiver 200, an coaxial-connector 202, a tuner 204, a Surface Acoustic Wave (SAW) filter 206, an Analog-to-Digital Converters (ADC) 208, an analog demodulator 210, a digital demodulator 212, an analog video/audio decoder (VDEC) 214, a digital video decoder (VDEC) 216, and an Automatic Gain Control (AGC) amplifier 218.

The coaxial-connector 202 may comprise suitable logic, circuitry, and/or code that may enable inputting, into the television receive 200, of television signals that may be transmitted over the air and/or via wired connections. For example, the coaxial-connector 202 may comprise an F-connector that may enable inputting terrestrial television signals transmitted over the air, and received via antennas. The coaxial-connector 202 may also enable inputting Cable Television (CATV) signals received, directly, via cable network.

The tuner 204 may comprise suitable logic, circuitry, and/or code that may enable tuning to any of various channels that may be utilized to carry television signals, which may be converted, via the tuner 204, to intermediate frequency (IF) signals that may be processed via the TV receiver 200. For example, the tuner 204 may enable tuning to any of channels 2 through 69, which may be utilized for terrestrial TV broadcast over the air, or up to channel 125, which may be utilized in most CATV networks. The tuner 204 may then enable reception of signals carried via the tuned channels, and to convert the received signals to IF signals, which may typically be in the 36.125 MHz or the 44 MHz range. Other IF frequencies may also be utilized comprising, for example, 57 MHz, and/or “low IF” signals that maybe less then 10 MHz. The signals received via the tuner 204 may either comprise TV signals that may comprise analog format, such as NTSC, PAL, or SECAM; or the signals received may comprise a digital format, such as QAM, VSB, or OFDM.

The SAW filter 206 may comprise suitable logic, circuitry, and/or code that may enable filtering an input signal to remove unwanted components in the signal. For example, utilizing SAW filter 206 may enable performing signal filtering on IF signals generating in the tuner 204, to reject adjacent channel interference (ACI), when receiving TV signals comprising analog or digital modulation format.

The ADC 208 may comprise suitable logic, circuitry, and/or code that may enable generation of binary and/or discrete information from an analog input signal; in other words, the ADC 208 may enable performing signal sampling to convert received continuous signals to discrete digitalized signals, which may then be processed utilizing digital signal processing techniques. The ADC 208 may also comprise additional suitable logic, circuitry, and/or code that may enable specifically generation of discrete digitalized signals that correspond to TV signals that comprise analog modulation format. The ADC 208 may also comprise additional suitable logic, circuitry, and/or code that may enable specifically generation of discrete digitalized signals that correspond to TV signals that comprise digital modulation format.

The analog demodulator 210 may comprise suitable logic, circuitry, and/or code that may enable digital demodulation of signals that may utilize an analog modulation scheme. For example, the analog demodulator 210 may enable demodulating received TV signals that comprise an analog modulation format scheme, such as NTSC, PAL, and/or SECAM. Additionally, the analog demodulator 210 may also comprise suitable logic, circuitry, and/or code that may enable digital demodulation to extract audio information encoded via an audio modulation scheme. For example, the analog demodulator 210 may enable extraction of audio information that may be carried via TV signals comprising separate audio modulation scheme, which may comprise BTSC, NICAM, Korean A-2, mono FM, and/or AM.

The digital demodulator 212 may comprise suitable logic, circuitry, and/or code that may enable digital demodulation of signals that may utilize a digital modulation scheme. For example, the digital demodulator 212 may enable demodulating received TV signals that were encoded via a digital modulation format scheme, which may comprise QAM, VSB, and/or OFDM.

The analog VDEC 214 may comprise suitable logic, circuitry, and/or code that may enable processing demodulated TV signals, transmitted via analog modulation format scheme, to enable displaying corresponding video images, and/or audio, via a TV display, for example the TV 102. The analog VDEC 214 may also comprise suitable logic, circuitry, and/or code that may enable processing demodulated audio signals, transmitted via a specific audio modulation scheme, to enable playing corresponding audio steams.

The digital VDEC 216 may comprise suitable logic, circuitry, and/or code that may enable processing demodulated TV signals, transmitted via digital modulation format scheme, to enable displaying corresponding video images, and/or audio, via a TV display, for example the TV 102. For example, the digital VDEC 216 may comprise an MPEG decoder that may enable processing digital video streams encoded via MPEG encoding standard.

The AGC amplifier 218 may comprise suitable logic, circuitry, and/or code that may enable automatic amplification of an input signals. For example, the AGC amplifier 218 may enable automatic amplification of filtered signals inputted from the tuner 204 to enable optimal performance by the ADC 208.

In operation, the tuner 204 may enable tuning to a channel and/or frequency that may enable reception of TV signals via the coaxial-connector 202. For example, the tuner 204 may enable tuning to any of channels 2 through 69, which may be utilized for terrestrial TV broadcast over the air, or up to higher channels, for example channel 125, which may be utilized for TV reception via CATV networks. The TV signals received via the tuned channels may either comprise an analog format, such as NTSC, PAL, or SECAM; or they may comprise a digital format such as QAM, VSB, or OFDM. The tuner 204 may enable conversion of the received TV signals to IF signals, which may typically be in the 36.125 MHz or the 44 MHz range, to enable processing TV reception via the TV receiver 200.

The IF signals generated in the tuner 204 may then be forwarded to the SAW filter 206. The SAW filter 206 may filter the forwarded IF signals, which correspond to received TV signals, to remove unwanted components in the signals, for example, reducing adjacent channel interference (ACI). The filtered signals may then be amplified via the AGC amplifier 218, and the amplified signals may then be inputted into the ADC 208. The ADC 208 may enable conversion of filtered signals, carrying TV signals, to discrete digitalized signals that may be processed digitally. In instances where the received TV signals may be determined to comprise analog modulation format, any additional conversion operations specific to analog modulation format may be performed in the ADC 208, and the resulting digitalized output may then be forwarded to the analog demodulator 210. Alternatively, in instances where the received TV signals may be determined to comprise digital modulation format, any additional conversion operations specific to digital modulation format may be performed in the ADC 208, and the resulting digitalized output may then be forwarded to the digital demodulator 212.

The analog demodulator 210 may enable demodulation of digitalized IF signals corresponding to carrier signals, which may carry TV signals comprising analog modulation scheme. For example, the analog demodulator 210 may enable demodulating received TV signals that were encoded via an analog modulation format scheme, which may comprise NTSC, PAL, and/or SECAM. Additionally, the analog demodulator 210 may enable extraction of audio information that may be carried via TV signals comprising separate audio modulation scheme, which may comprise BTSC, NICAM, Korean A-2, mono FM, and/or AM. Demodulating received TV signals, via the analog demodulator 210, may enable extraction of information corresponding to video and/or audio content of an analog TV broadcast and/or telecast. The information extracted via the demodulator 210 may then be forwarded to the analog VDEC 214, wherein the analog VDEC 214 may enable decoding video and/or audio information that may be encoded via analog modulation format schemes, for example NTSC and/or BTSC, to enable displaying generating video images and/or audio streams on a TV display, for example the TV 102, and/or dedicated sound systems for audio streams.

The digital demodulator 212 may enable demodulation of digitalized IF signals corresponding to carrier signals, which may carry TV signals comprising digital modulation scheme. For example, the digital demodulator 212 may enable demodulating received TV signals that were encoded via a digital modulation format scheme, which may comprise QAM, VSB, and/or OFDM. Demodulating the received TV signals, via the digital demodulator 212, may enable extraction of information corresponding to video and/or audio content of a digital TV broadcast and/or telecast. The information extracted via the digital demodulator 212 may then be forwarded to the digital VDEC 216, wherein the digital VDEC 216 may enable decoding video and/or audio information that may be encoded via digital modulation format scheme, for example MPEG, to enable generating corresponding video images and/or audio streams on a TV display, for example the TV 102, and/or dedicated sound systems for audio streams.

The TV receiver 200 may be integrated into a TV, for example the TV 102, to facilitate reception of TV broadcasts from TV head-ends, for example, the terrestrial-TV head 104, the CATV head-end 110, and/or the satellite head-end 114. Alternatively, the TV receiver 200 may be integrated into a dedicated device, for example the set-top box 118, which may enable performing some or all of necessary A/V processing operations pertaining to reception of TV broadcasts external to TVs, for example the TV 102.

In addition to enabling reception of TV broadcasts, the TV receiver 200 may also enable A/V feeds from local sources, which may comprise analog or digital modulation formats. For example, the consumer audiovisual device 120 may be utilized to input into the TV 102 A/V feeds, wherein the A/V feeds may be received via the coaxial-connector 202 in the TV receiver 200, for example. However, use of TV receivers to receive A/V feeds from consumer audiovisual devices may cause some problems and/or challenges. The consumer audiovisual device 120 may be designed to operate with specific formats and/or specific connectors, and may not be configurable to accommodate newer technologies and/or connector types. For example, with VCRs, the A/V feeds may be generated utilizing channel 3 (60 MHz) and/or channel 4 (66 MHz), comprising analog modulation format, for example NTSC, and VCR's connectivity to TVs may generally be limited to coaxial-connectors. Additionally, use of TV receivers in conjunction with consumer audiovisual devices may not be convenient where the same connector, for example the coaxial-connector 202 in the TV receiver 200, may be utilized for both reception of TV broadcasts and inputting of A/V feeds from consumer audiovisual devices. Consequently, to enable backward compatibility of the consumer audiovisual device 120, without impacting continued and/or convenient TV broadcast reception operations, a second coaxial-connector, dedicated to A/V feeds from consumer audiovisual devices may be added to TV receivers, such as the TV receivers 200, along with the minimally necessary hardware and software additions and/or modifications, may enable facilitating backward compatibility at minimal cost and/or added processing.

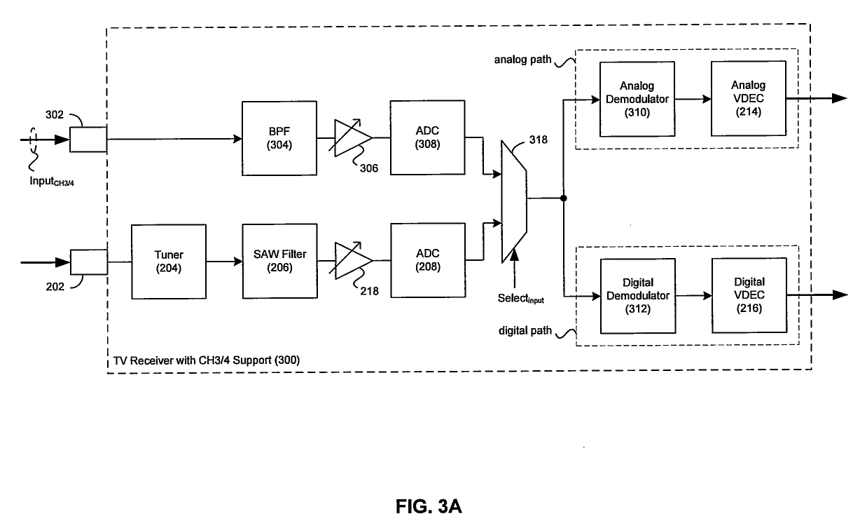

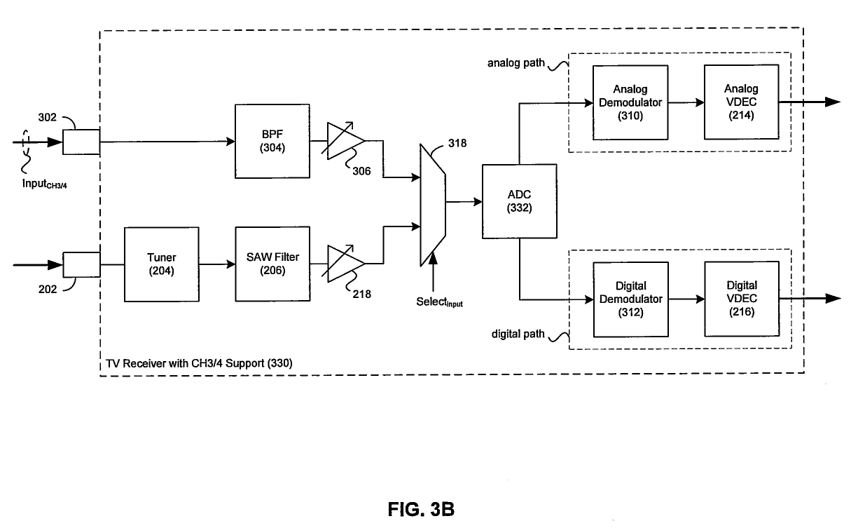

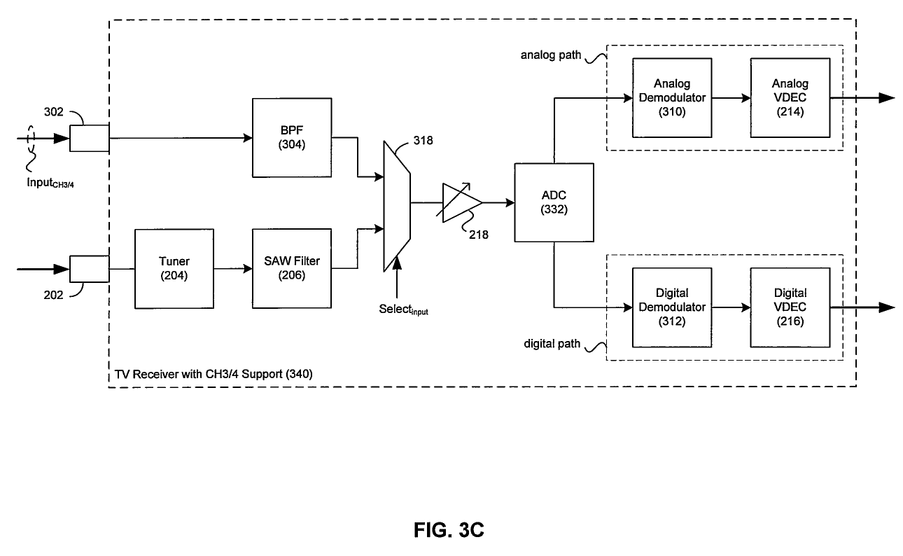

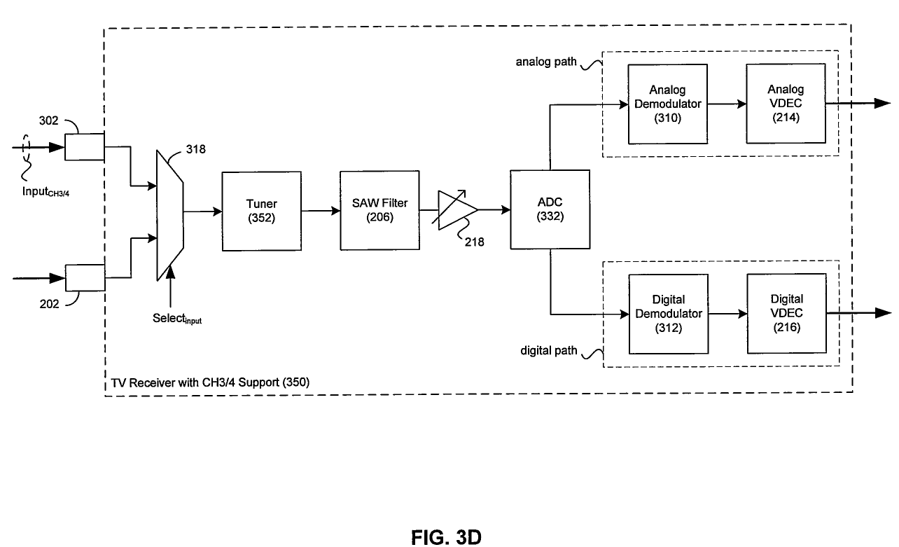

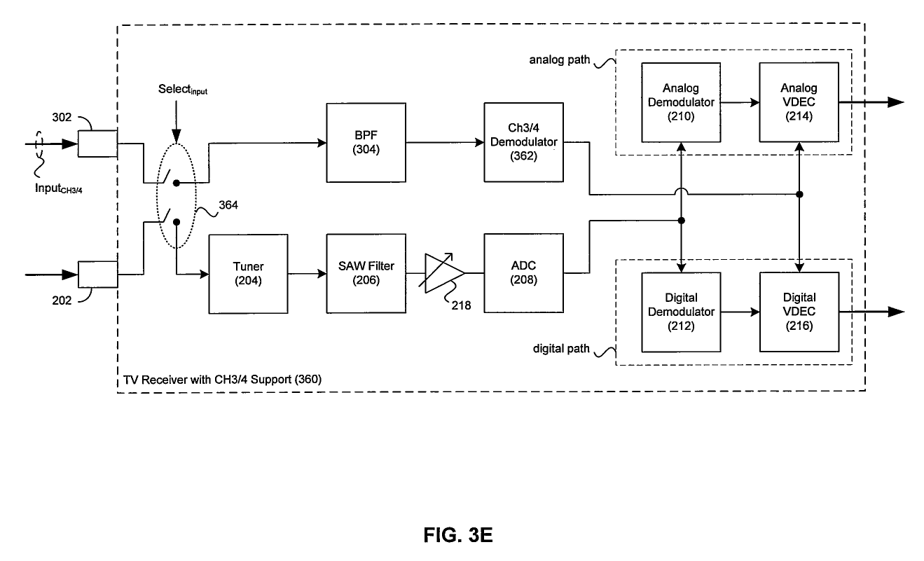

FIG. 3A is a block diagram illustrating an exemplary television receiver with Channel 3/4 support via a dedicated coaxial-connector, which utilizes a separate Analog-to-Digital Converter (ADC) for Channel 3/4 processing, in accordance with an embodiment of the invention. Referring to FIG. 3A, there is shown a TV receiver with CH3/4 support 300, the coaxial-connector 202, the tuner 204, the Surface Acoustic Wave (SAW) filter 206, the Analog-to-Digital Converters (ADC) 208, the analog video/audio decoder (VDEC) 214, the digital video decoder (VDEC) 216, the Automatic Gain Control (AGC) amplifier 218, a CH3/4 coaxial-connector 302, a Band-Pass Filter (BPF) 304, an Automatic Gain Control (AGC) amplifier 306, a CH3/4 Analog-to-Digital Converters (ADC) 308, an analog demodulator 310, a digital demodulator 312, and a signal multiplexer (MUX) 318.

The coaxial-connector 202, the tuner 204, the SAW filter 206, the ADC 208, the analog VDEC 214, and the digital VDEC 216 may be comprised substantially as described with respect to FIG. 2.

The CH3/4 coaxial-connector 302 may be comprised substantially similar to the coaxial-connector 202, as described in FIG. 2. The CH3/4 coaxial-connector 302 may be used exclusively for A/V feed inputted from local sources, wherein the A/V feed may comprise analog or digital modulation formats. For example, the consumer audiovisual device 120 may generate A/V feed, over channel 3 and/or channel 4, which may be inputted into TV receiver 300, via the CH3/4 coaxial-connector 302.

The BPF 304 may comprise suitable logic, circuitry, and/or code that may enable passing only frequencies within specific bands. For example, the BPF 304 may enable passing frequencies corresponding to channel 3 and/or channel 4 while filtering out other frequencies.

The AGC amplifier 306 may comprise suitable logic, circuitry, and/or code that may enable automatic amplification of an input signals. For example, the AGC amplifier 306 may enable automatic amplification of filtered signals inputted from the BPF 304 to enable optimal performance by the CH3/4 ADC 308.

The CH3/4 ADC 308 may be comprised substantially similar to the ADC 208, as described in FIG. 2; however, the CH3/4 ADC 308 may be exclusively restricted to perform analog-to-digital conversion operation pertaining to pre-set channels that may be utilized by local sources. For example, the CH3/4 ADC 308 may enable performing analog-to-digital conversion on A/V feed inputted via channel 3 and/or channel 4, from the consumer audiovisual device 120.

The analog demodulator 310 may comprise suitable logic, circuitry, and/or code that may enable digital demodulation of signals that may utilize an analog modulation scheme. For example, the analog demodulator 310 may enable demodulating received TV signals that comprise an analog modulation format scheme, such as NTSC, PAL, and/or SECAM. The analog demodulator 310 may also comprise suitable logic, circuitry, and/or code that may enable digital demodulation to extract audio information encoded via an audio modulation scheme. For example, the analog demodulator 310 may enable extraction of audio information that may be carried via TV signals comprising separate audio modulation scheme, which may comprise BTSC, NICAM, Korean A-2, mono FM, and/or AM. Additionally, the analog demodulator 310 may enable, if necessary, demodulating input corresponding to pre-set channels that may be utilized by local sources. For example, the analog demodulator 310 may enable demodulation of A/V feed inputted via channel 3 and/or channel 4, from the consumer audiovisual device 120.

The digital demodulator 312 may comprise suitable logic, circuitry, and/or code that may enable digital demodulation of signals that may utilize a digital modulation scheme. For example, the digital demodulator 312 may enable demodulating received TV signals that were encoded via a digital modulation format scheme, which may comprise QAM, VSB, and/or OFDM. Additionally, the digital demodulator 312 may enable, if necessary, demodulating input corresponding to pre-set channels that may be utilized by local sources. For example, the digital demodulator 312 may enable demodulation of digital A/V feed inputted via channel 3 and/or channel 4, from the consumer audiovisual device 120.

The MUX 318 may comprise suitable logic, circuitry, and/or code that may enable selecting an output signal, from a plurality of available inputs signals.

In operation, when processing TV and/or A/V signals, the MUX 318 may enable switching between the coaxial-connector 202 and the CH3/4 coaxial-connector 302. In instances where the TV receiver 300 may not be utilized for processing CH3/4 input, the “Selectᵢₙₚᵤₜ” may be set to enable the MUX 318 to select input from the ADC 208. Consequently, the TV receiver 300 may perform substantially similar to the TV receiver 200, as described in FIG. 2.

However, in instances where the TV receiver 300 may be utilized for processing CH3/4 input, the “Selectᵢₙₚᵤₜ” may be set or configured to enable the MUX 318 to select input from the ADC 308, and deselect the input from the ADC 208. The CH3/4 input may be received via the CH3/4 coaxial-connector 302. The CH3/4 input may then be passed via the BPF 304 to filter out any frequencies that may not be within the pre-set channels that may be utilized in conjunction with the CH3/4 coaxial-connector 302. For example, the BPF 304 may only enable passing of frequencies corresponding to channel 3 and/or channel 4. The filtered signals may then be amplified via the AGC amplifier 306, and the amplified signals may then be inputted into the CH3/4 ADC 308 to enable performing analog-to-digital conversion. The converted digitalized signals may then pass, via the MUX 318, to the analog demodulator 310 or the digital demodulator 312.

In instances where the A/V feed from the consumer audiovisual device comprise 120 may comprise analog modulation format, that may comprise NTSC, PAL and/or SECAM, the analog demodulator 310 may enable demodulating the inputted A/V feed from the consumer audiovisual device 120. Additionally, the analog demodulator 310 may enable demodulation of the audio content of the inputted A/V feed where separate audio modulation scheme, comprising, for example, BTSC, NICAM, Korean A-2, mono FM, and/or AM, may have be utilized. The demodulating A/V feed may then be forwarded to the analog VDEC 214, wherein the analog VDEC 214 may utilize the information to enable displaying corresponding video images on a TV display, for example the TV 102.

In instances where the where the A/V feed from the consumer audiovisual device 120 may comprise digital modulation format, that may comprise QAM, VSB, and/or OFDM, the digital demodulator 312 may enable demodulating the inputted digital A/V feed from the consumer audiovisual device 120. The demodulating A/V feed may then be forwarded to the digital VDEC 216, wherein the digital VDEC 216 may utilize the information to enable displaying corresponding video images on a TV display, for example the TV 102.

FIG. 3B is a block diagram illustrating an exemplary television receiver with Channel 3/4 support via a dedicated coaxial-connector, which utilizes a common Analog-to-Digital Converter (ADC) for signal processing, in accordance with an embodiment of the invention. Referring to FIG. 3B, there is shown a TV receiver with CH3/4 support 330, the coaxial-connector 202, the tuner 204, the Surface Acoustic Wave (SAW) filter 206, the analog video/audio decoder (VDEC) 214, the digital video decoder (VDEC) 216, the Automatic Gain Control (AGC) amplifier 218, the CH3/4 coaxial-connector 302, the Band-Pass Filter (BPF) 304, the Automatic Gain Control (AGC) filter 306, the analog demodulator 310, the digital demodulator 312, the signal multiplexer (MUX) 318, and a common-path Analog-to-Digital Converter (ADC) 332.

The coaxial-connector 202, the tuner 204, the SAW filter 206, the analog VDEC 214, the digital VDEC 216, and the AGC amplifier 218 may be comprised substantially as described with respect to FIG. 2. The CH3/4 coaxial-connector 302, the BPF 304, the AGC amplifier 306, the analog demodulator 310, the digital demodulator 312, and the MUX 318 may be comprised substantially as described with respect to FIG. 3A.

The common-path ADC 332 may comprise suitable logic, circuitry, and/or code that may enable performing the combined functionality of the ADC 208, as described with respect to FIG. 2, and the CH3/4 ADC 308, as described in FIG. 3A. Specifically, the common-path ADC 332 may enable performing analog-to-digital conversion operations on signals received from tuned channels via the coaxial-connector 202 and the tuner 204; or performing analog-to-digital conversion on A/V feed inputted via channel 3 and/or channel 4, from the consumer audiovisual device 120. The ADC 332 may perform signal sampling to convert continuous signals to discrete digitalized signals, which may then be processed utilizing digital signal processing techniques.

In operation, when processing TV and/or A/V signals, the MUX 318 may enable switching between the coaxial-connector 202 and the CH3/4 coaxial-connector 302. Where the TV receiver 330 may not be utilized for processing CH3/4 input, the “Selectᵢₙₚᵤₜ” may be set to enable the MUX 318 to select input from the AGC amplifier 218. Consequently, the TV receiver 330 may perform substantially similar to the TV receiver 200, as described in FIG. 2, wherein the common-path ADC 332 may operate substantially similar to the ADC 208.

However, in instances where the TV receiver 330 may be utilized for processing CH3/4 input, the “Selectᵢₙₚᵤₜ” may be set to enable the MUX 318 to select input from the AGC amplifier 306, and deselect the input from the AGC amplifier 218. The CH3/4 input may be received via the CH3/4 coaxial-connector 302. The CH3/4 input may then be passed via the BPF 304 to filter out any frequencies that may not be within the pre-set channels that may be utilized in conjunction with the CH3/4 coaxial-connector 302. For example, the BPF 304 may only enable passing of frequencies corresponding to channel 3 and/or channel 4. The filtered signals may then be amplified via the AGC amplifier 306. The amplified signal may then pass, via the MUX 318, to the common-path ADC 332 to enable performing analog-to-digital conversion on the amplified signals. The converted digitalized signals may then be inputted to the analog demodulator 310 and/or the digital demodulator 312.

In instances where the A/V feed from the consumer audiovisual device 120 may comprise analog modulation format, that may comprise NTSC, PAL and/or SECAM, the analog demodulator 310 may enable demodulating the inputted A/V feed from the consumer audiovisual device 120. Additionally, the analog demodulator 210 may enable demodulation of the audio content of the inputted A/V feed where separate audio modulation scheme, comprising, for example, BTSC, NICAM, Korean A-2, mono FM, and/or AM, may have be utilized. The demodulating A/V feed may then be forwarded to the analog VDEC 214, wherein the analog VDEC 214 may utilize the information to enable displaying corresponding video images on a TV display, for example the TV 102.

In instances where the where the A/V feed from the consumer audiovisual device 120 may comprise digital modulation format, that may comprise QAM, VSB, and/or OFDM, the digital demodulator 312 may enable demodulating the inputted digital A/V feed from the consumer audiovisual device 120. The demodulating A/V feed may then be forwarded to the digital VDEC 216, wherein the digital VDEC 216 may utilize the information to enable displaying corresponding video images on a TV display, for example the TV 102.

FIG. 3C is a block diagram illustrating an exemplary television receiver with Channel 3/4 support via a dedicated coaxial-connector, which utilizes a common Analog-to-Digital Converter (ADC) and a single amplifier for signal processing, in accordance with an embodiment of the invention. Referring to FIG. 3C, there is shown a TV receiver with CH3/4 support 340, the coaxial-connector 202, the tuner 204, the Surface Acoustic Wave (SAW) filter 206, the analog video/audio decoder (VDEC) 214, the digital video decoder (VDEC) 216, the Automatic Gain Control (AGC) amplifier 218, the CH3/4 coaxial-connector 302, the Band-Pass Filter (BPF) 304, the analog demodulator 310, the digital demodulator 312, the signal multiplexer (MUX) 318, and the common-path Analog-to-Digital Converter (ADC) 332.

The coaxial-connector 202, the tuner 204, the Surface Acoustic Wave (SAW) filter 206, the analog video/audio decoder (VDEC) 214, the digital video decoder (VDEC) 216, and the Automatic Gain Control (AGC) amplifier 218 may be comprised substantially as described with respect to FIG. 2. The CH3/4 coaxial-connector 302, the Band-Pass Filter (BPF) 304, the analog demodulator 310, the digital demodulator 312, and the MUX 318 may be comprised substantially as described with respect to FIG. 3A. The common-path ADC 332 may be comprised substantially as described with respect to FIG. 3B.

In operation, the TV receiver 340 may operate substantially similar to the TV receiver 330, as described in FIG. 3B; however, the TV receiver 340 may utilize a single amplifier, the AGC amplifier 218. When processing TV and/or A/V signals, the MUX 318 may enable switching between the coaxial-connector 202 and the CH3/4 coaxial-connector 302. Where the TV receiver 340 may not be utilized for processing CH3/4 input, the “Selectᵢₙₚᵤₜ” may be set to enable the MUX 318 to select input from the SAW filter 206. Consequently, the TV receiver 340 may perform substantially similar to the TV receiver 200, as described in FIG. 2, wherein the common-path ADC 332 may operate substantially similar to the ADC 208.

However, in instances where the TV receiver 340 may be utilized for processing CH3/4 input, the “Selectᵢₙₚᵤₜ” may be set to enable the MUX 318 to select input from the BPF 304, and deselect the input from the SAW filter 306. The CH3/4 input may be received via the CH3/4 coaxial-connector 302, and the CH3/4 input may then be passed via the BPF 304 to filter out any frequencies that may not be within the pre-set channels that may be utilized in conjunction with the CH3/4 coaxial-connector 302. The filtered CH3/4 signals may pass, via the MUX 318, to the AGC amplifier 218, and the amplified signals may then be inputted into the common-path ADC 332, wherein processing of amplified signal may be performed substantially as described in FIG. 3B.

FIG. 3D is a block diagram illustrating an exemplary television receiver with Channel 3/4 support via a dedicated coaxial-connector, which utilizes a common tuner, in accordance with an embodiment of the invention. Referring to FIG. 3D, there is shown a TV receiver with CH3/4 support 350, the coaxial-connector 202, the Surface Acoustic Wave (SAW) filter 206, the analog video/audio decoder (VDEC) 214, the digital video decoder (VDEC) 216, the Automatic Gain Control (AGC) amplifier 218, the CH3/4 coaxial-connector 302, the analog demodulator 310, the digital demodulator 312, the signal multiplexer (MUX) 318, the common-path Analog-to-Digital Converter (ADC) 332, and a common-path tuner 352.

The coaxial-connector 202, the Surface Acoustic Wave (SAW) filter 206, the analog video/audio decoder (VDEC) 214, the digital video decoder (VDEC) 216, and the Automatic Gain Control (AGC) amplifier 218 may be comprised substantially as described with respect to FIG. 2. The CH3/4 coaxial-connector 302, the analog demodulator 310, the digital demodulator 312, and the MUX 318 may be comprised substantially as described with respect to FIG. 3A. The common-path ADC 332 may be comprised substantially as described with respect to FIG. 3B.

The common-path tuner 352 may be comprised substantially similar to the tuner 204 to enable tuning to any of various broadcast channels that may be utilized to carry television signals, which may be converted to intermediate frequency (IF) signals, which may be processed via the TV receiver 350. Additionally, the common-path tuner 352 may comprise suitable logic, circuitry, and/or code that may enable tuning into any of pre-set channels that may be utilized by a local source, such as audiovisual consumer devices, to input A/V feed into the TV receiver 350, and to convert received A/V signals to IF signals. For example, the common-path tuner 352 may enable tuning into channel 3 and/or 4 that may be utilized by the consumer audiovisual device 120, and to convert A/V signals received, via the CH3/4 coaxial-connector 302, to IF signals.

In operation, the TV receiver 350 may operate substantially similar to the TV receiver 330, as described in FIG. 3B; however, the TV receiver 350 may utilize a single tuner, the common-path tuner 352. When processing TV and/or A/V signals, the MUX 318 may enable switching between the coaxial-connector 202 and the CH3/4 coaxial-connector 302. Where the TV receiver 350 may not be utilized for processing CH3/4 input, the “Selectᵢₙₚᵤₜ” may be set to enable the MUX 318 to select input from the coaxial-connector 202. Consequently, the TV receiver 350 may perform substantially similar to the TV receiver 200, as described in FIG. 2, wherein the common-path tuner 352 may operate substantially similar to the tuner 204.

However, in instances where the TV receiver 350 may be utilized for processing CH3/4 input, the “Selectᵢₙₚᵤₜ” may be set to enable the MUX 318 to select input from the CH3/4 coaxial-connector 302, and deselect the input from the coaxial-connector 202. The CH3/4 input may then be passed to the common-path tuner 352, wherein the common-path tuner 352 may be enabled to tune into channels that may be utilized to input A/V feed via CH3/4 coaxial-connector 302, and may convert the CH3/4 signals to corresponding IF signals, substantially similar to operations performed on broadcast TV signals. The SAW filter 206 may filter the forwarded IF signals, which correspond to CH3/4 signals, to remove unwanted components in the signals, for example, reducing adjacent channel interference (ACI). The filtered signals may then be amplified via the AGC amplifier 218, and the amplified signals may then be inputted into the common-path ADC 332, wherein processing of amplified signals may be performed substantially as described in FIG. 3B.

FIG. 3E is a block diagram illustrating an exemplary television receiver with Channel 3/4 support via a dedicated coaxial-connector, which utilizes a dedicated Channel 3/4 demodulator, in accordance with an embodiment of the invention. Referring to FIG. 3E, there is shown a TV receiver with CH3/4 support 360, the coaxial-connector 202, the tuner 204, the Surface Acoustic Wave (SAW) filter 206, the Analog-to-Digital Converters (ADC) 208, the analog demodulator 210, the digital demodulator 212, the analog video/audio decoder (VDEC) 214, the digital video decoder (VDEC) 216, the Automatic Gain Control (AGC) amplifier 218, the CH3/4 coaxial-connector 302, the Band-Pass Filter (BPF) 304, a CH3/4 demodulator 362, and a switching element 364.

The coaxial-connector 202, the tuner 204, the Surface Acoustic Wave (SAW) filter 206, the Analog-to-Digital Converters (ADC) 208, the analog demodulator 210, the digital demodulator 212, the analog video/audio decoder (VDEC) 214, the digital video decoder (VDEC) 216, the Automatic Gain Control (AGC) amplifier 218 may be comprised substantially as described with respect to FIG. 2. The CH3/4 coaxial-connector 302 and the Band-Pass Filter (BPF) 304 may be comprised substantially as described with respect to FIG. 3B.

The CH3/4 demodulator may comprise suitable logic, circuitry, and/or code that may enable direct demodulation of A/V feed that may be inputted via one or more pre-set channels. For example, the CH3/4 demodulator 362 may comprise an analog Integrated Circuit (IC) that may enable demodulating analog video and/or audio signals inputted, via the CH3/4 coaxial-connector 302, from the consumer audiovisual device 120, utilizing channel 3 and/or channel 4. The switch element 364 may comprise suitable logic, circuitry, and/or code that may enable switching on and off one or more of available paths within said switching element. For example, the switching element 364 may enable switching, on or off, either a path between the coaxial-connector 202 and the tuner 204, or a path between the CH3/4 coaxial-connector 302 and the BPF 304. The determination of which path to switch on and/or off may be based on selection input, for example, the “Selectᵢₙₚᵤₜ.”

In operation, when processing TV and/or A/V signals, the switching element 364 may enable switching between the coaxial-connector 202 and the CH3/4 coaxial-connector 302. In instances where the TV receiver 360 may not be utilized for processing CH3/4 input, the “Selectᵢₙₚᵤₜ” may be utilized to enable the switching element 364 to switch on the path between the coaxial-connector 202 and the tuner 204; and to switch off the path between the CH3/4 coaxial-connector 302 and the BPF 304. Consequently, the TV receiver 360 may perform substantially similar to the TV receiver 200, as described in FIG. 2.

However, in instances where the TV receiver 360 may be utilized for processing CH3/4 input, the “Selectᵢₙₚᵤₜ” may be utilized to enable the switching element 364 to switch off the path between the coaxial-connector 202 and the tuner 204; and to switch on the path between the CH3/4 coaxial-connector 302 and the BPF 304. The CH3/4 input may then be passed via the BPF 304 to filter out any frequencies that may not be within the pre-set channels that may be utilized in conjunction with the CH3/4 coaxial-connector 302. The filtered CH3/4 signals may then be inputted into the CH3/4 demodulator 362. The CH3/4 demodulator 362 may then directly demodulate the filtered CH3/4 signals, based on pre-determined channels and/or modulation formats, to enable extraction of information corresponding to video and/or audio content the CH3/4 input signals. Notably, with use of CH3/4 demodulator 362 for direct demodulation of A/V feed from local sources, the received signals may need not to be converted to IF signals during processing operations.

The information extracted via the CH3/4 demodulator 362 may then be forwarded to the analog VDEC 214 and/or the digital VDEC 216 to enable decoding video and/or audio information that may enable generating video images and/or audio streams on a TV display, for example the TV 102, and/or dedicated sound systems for audio streams; substantially as described in FIG. 2.

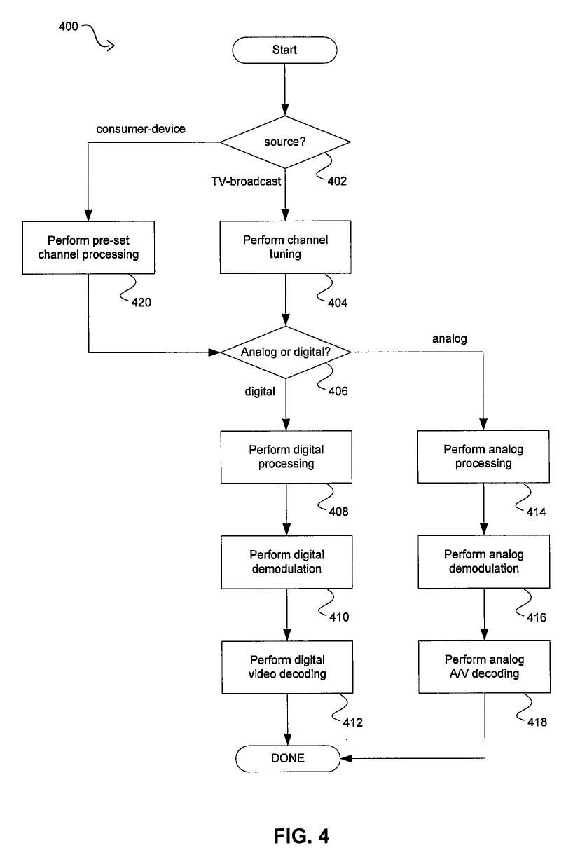

FIG. 4 is an exemplary flow diagram illustrating a television receiver with Channel 3/4 support via a dedicated coaxial-connector, in accordance with an embodiment of the invention. Referring to FIG. 4, there is shown a flow chart 400 comprising a plurality of exemplary steps.

In step 402, a determination of the source of input into a TV receiver may be made. For example, “Selectᵢₙₚᵤₜ” may enable determining whether the TV receiver 300 is receiving signals via the coaxial-connector 202 or the CH3/4 coaxial-connector 302. In instances where it may be determined that a TV receiver, for example the TV receiver 300, may be utilized for processing TV broadcast, for example, from the terrestrial-TV head-end 104, CATV head-end 110, and/or satellite head-end 114, the process may proceed to step 404.

In step 404, channel tuning operations may be performed. For example, the tuner 204 may enable tuning to a channel and/or frequency that may be utilized to facilitate reception of TV signal via the coaxial-connector 202. The tuner 204 may enable tuning to any of channels 2 through 69, which may be utilized for terrestrial TV broadcast over the air, or up to higher channels, for example channel 125, which may be utilized for TV reception via CATV networks. Additionally, during tuning, received signals may be converted to intermediate frequency (IF) signals. For example, the tuner 204 may enable conversion of the received TV signals to IF signals, which may typically be in the 36.125 MHz or the 44 MHz range, to enable processing TV reception via the TV receiver 300. The received TV signals may be filtered, via the SAW filter 206 for example, to remove unwanted components in the signals, for example, reducing adjacent channel interference (ACI). The filtered signals may then be amplified, via the AGC amplifier 218 for example.

In step 406, a determination of the type of modulation utilized with the signals received via the channel tuned to in step 404 may be determined. The TV signals received via the tuned channels may either comprise an analog format, such as NTSC, PAL, or SECAM; or it may comprise a digital format such as QAM, VSB, or OFDM. In the instances that the received TV signals comprise digital modulation format, the process may proceed to step 408.

In step 408, processing of IF signals that correspond to received TV signals comprising digital modulation format may be performed. The received signals may be processed to perform analog-to-digital conversion. For example, the ADC 208 may enable conversion of filtered IF signals, comprising digital modulation format, from continuous signals to discrete digitalized signals that may be processed digitally. The process may then proceed to step 410. In step 410, IF signals that correspond to received TV signals comprising digital modulation format may be demodulated. For example, the digital demodulator 212 may enable demodulation of digitalized IF signals corresponding to TV signals comprising digital modulation format scheme, which may comprise QAM, VSB, and/or OFDM, to enable extraction of encoded video and/or audio information in the TV broadcast. The process may then proceed to step 412. In step 412, video information extracted from TV and/or A/V feeds, which comprising digital modulation format, may be decoded to enable displaying corresponding video images on a TV display. For example, the digital VDEC 216 may be utilized to decode video information extracted, via digital demodulation, to enable displaying corresponding video images on the TV 102.

Returning to step 406, in instances where the received TV signals comprise analog modulation format, the process may proceed to step 414. In step 414, processing of IF signals that correspond to received TV signals comprising analog modulation format may be performed. The received signals may be processed to perform analog-to-digital conversion. For example, the ADC 208, in TV receiver 300, may enable conversion of filtered IF signals, comprising analog modulation format, from continuous signals to discrete digitalized signals that may be processed digitally. The process may then proceed to step 416. In step 416, IF signals that correspond to received TV signals comprising analog modulation format may be demodulated. For example, the analog demodulator 310, in the TV receiver 300, may enable demodulation of digitalized IF signals corresponding to TV signals comprising analog modulation format scheme, which may comprise NTSC, PAL, and/or SECAM; and may also comprise audio modulation schemes such as BTSC, NICAM, Korean A-2, mono FM, and/or AM, to enable extraction of encoded video and/or audio information in the TV broadcast. The process may then proceed to step 418. In step 418, video information extracted from TV and/or A/V feeds, which comprising analog modulation format, may be decoded to enable displaying corresponding video images on a TV display. For example, the analog VDEC 214 may be utilized to decode video information extracted, via analog demodulation, to enable displaying corresponding video images on the TV 102.

Returning to step 402, in instances where it may be determined that a TV receiver, for example the TV receiver 300, may be utilized for processing modulated A/V feed from a consumer audiovisual device, for example from the consumer audiovisual device 120, the process may proceed to step 420. In step 420, processing of the pre-set channel utilized for localized A/V feed may be performed. For example, the TV receiver 300 may be set to receive CH3/4 input, via the CH3/4 coaxial-connector 302, from the consumer audiovisual device 120. The CH3/4 input may be received via the CH3/4 coaxial-connector 302. The CH3/4 input may then be passed via the BPF 304 to filter out any frequencies that may not be within the pre-set channels that may be utilized in conjunction with the CH3/4 coaxial-connector 302. For example, the BPF 304 may only enable passing of frequencies corresponding to channel 3 and/or channel 4. The filtered signals may also be amplified via a dedicated amplifier, for example the AGC amplifier 306. The amplified signals may be converted, via dedicated ADC such as the CH3/4 ADC 308, from continuous signals to discrete digitalized signals that may be processed digitally, or alternatively, a common ADC, for example the common-path ADC 332 may be utilized to perform analog-to-digital conversion. The process may then proceed to step 406 to enable processing the A/V feed from the local sources.

Various embodiments of the invention may comprise a method and system for direct sampled digital and analog demodulator TV receiver with backwards compatibility. The TV receiver 300 may be utilized to directly sample digital or analog format TV signals that may be received via the coaxial-connector 202 from one or more of available TV broadcast head-ends, comprising the terrestrial-TV head end 104, the CATV head-end 110, or satellite head-end 114. The tuner 204 may be utilized to tune to a broadcast channel. The TV receiver 300 may enable processing of TV signals comprising analog modulation format schemes such as NTSC, PAL, and/or SECAM; audio modulation schemes such as BTSC, NICAM, Korean A-2, mono FM, and/or AM; and/or digital modulation format scheme such as QAM, VSB, and/or OFDM. Exemplary processing may comprise filtering via SAW filter 206, analog-to-digital conversions via the ADC 208, and demodulation via the analog demodulator 310 and/or digital demodulator 312 to extract video and/or audio content. The CH3/4 coaxial-connector 302 may be added in the TV receiver 300 to ensure backwards compatibility with the consumer audiovisual device 120, wherein Audio/Video (A/V) modulated feed from consumer audiovisual device 120, CH3/4 input, may be inputted directly into the TV receiver 300, via the CH3/4 connector 302. The CH3/4 input may be demodulated via common demodulators, for example the analog demodulator 310 and/or the digital demodulator 312, in the TV receiver 300. Initial processing the CH3/4 input may be performed via the BPF 304 and the AGC amplifier 306. Additionally, analog-to-digital conversion of the CH3/4 input may either be performed via the CH3/4 ADC 308, or via the common-path ADC 332. The CH3/4 input may also be demodulated directly, via the CH3/4 demodulator 362.

Another embodiment of the invention may provide a machine-readable storage, having stored thereon, a computer program having at least one code section executable by a machine, thereby causing the machine to perform the steps as described herein for direct sampled digital and analog demodulator TV receiver with backwards compatibility.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for improving television processing, the method comprising:
in a television receiver that enables processing broadcast television signals received via a first coaxial-connector, processing via said television receiver, video and/or audio signals received via a second coaxial-connector, utilizing one or more pre-set channels.

2. The method according to claim 1, wherein said one or more pre-set channels comprise channel 3 and/or channel 4.

3. The method according to claim 1, wherein said television receiver enables processing analog format modulated signals, digital format modulated signals, and/or modulated audio signals.

4. The method according to claim 3, wherein said digital format modulated signals comprise QAM, VSB, and OFDM signals.

5. The method according to claim 3, wherein said analog format modulated signals comprise NTSC, PAL, and SECAM signals.

6. The method according to claim 3, wherein said modulated audio signals comprise BTSC, Korean A-2, mono FM, AM, and NICAM signals.

7. The method according to claim 1, comprising demodulating, via a common demodulation function, said video and/or audio signals, received via said second coaxial-connector, and similarly modulated received broadcast television and/or audio signals via said first coaxial-connector.

8. The method according to claim 7, comprising selecting among said video and/or audio signals, received via said second coaxial-connector and received signals via said first coaxial-connector and/or other available input ports, during video and/or audio signal processing in said television receiver.

9. The method according to claim 7, comprising utilizing a common analog-to-digital conversion function for said video and/or audio signals, received via said second coaxial-connector and received signals via said first coaxial-connector and/or other available input ports, during video and/or audio signal processing in said television receiver.

10. The method according to claim 7, comprising utilizing a dedicated analog-to-digital conversion function for said video and/or audio signals, received via said second coaxial-connector during video and/or audio signal processing in said television receiver.

11. The method according to claim 1, comprising inputting said video and/or audio signals, received via said second coaxial-connector, from a local source.

12. The method according to claim 11, wherein said local source comprises a videocassette recorder (VCR), a digital video disc (DVD) player, a digital video recorder (DVR), a video game console, a surveillance system, a personal computer (PC) capture/playback card, and/or stand-alone modulator box.

13. A system for improving television processing, the system comprising:
a television receiver that enables processing broadcast television signals received via a first coaxial-connector, wherein said television receiver comprises one or more circuits that enable processing, via said television receiver, video and/or audio signals, received via a second coaxial-connector, utilizing one or more pre-set channels.

14. The system according to claim 13, wherein said one or more pre-set channels comprise channel 3 and/or channel 4.

15. The system according to claim 13, wherein said television receiver enables processing analog format modulated signals, digital format modulated signals, and/or modulated audio signals.

16. The system according to claim 15, wherein said digital format modulated signals comprise QAM, VSB, and OFDM signals.

17. The system according to claim 15, wherein said analog format modulated signals comprise NTSC, PAL, and SECAM signals.

18. The system according to claim 15, wherein said modulated audio signals comprise BTSC, Korean A-2, mono FM, AM, and NICAM signals.

19. The system according to claim 13, wherein said one or more processors enable common demodulation of said video and/or audio signals, received via said second coaxial-connector, and similarly modulated received broadcast television and/or audio signals via said first coaxial-connector.

20. The system according to claim 19, wherein said one or more circuits enable selection among said video and/or audio signals, received via said second coaxial-connector and said received signals via said first coaxial-connector and/or other available input ports, during video and/or audio signal processing in said television receiver.

21. The system according to claim 19, wherein said one or more circuits enable common analog-to-digital conversion of said video and/or audio signals, received via said second coaxial-connector and said received signals via said first coaxial-connector and/or other available input ports, during video and/or audio signal processing in said television receiver.

22. The system according to claim 19, wherein said one or more circuits enable dedicated analog-to-digital conversion of said video and/or audio signals, received via said second coaxial-connector during video and/or audio signal processing in said television receiver.

23. The system according to claim 13, wherein said one or more circuits enable inputting of said video and/or audio signals, received via said second coaxial-connector, from a local source.

24. The system according to claim 23, wherein said local source comprises a videocassette recorder (VCR), a digital video disc (DVD) player, a digital video recorder (DVR), a video game console, a surveillance system, a personal computer (PC) capture/playback card, and/or stand-alone modulator box.

25. The system according to claim 13, wherein said first coaxial-connector and/or said second coaxial-connector comprise F-connectors.
